(19) United States
(12) Patent Application Publication
(10) Pub. No.: US 2003/0146310 A1
(43) Pub. Date: Aug. 7, 2003

(54) Method, process and apparatus for high pressure plasma catalytic treatment of dense fluids

(76) Inventor: David P. Jackson, Saugus, CA (US)

Correspondence Address: SONNENSCHEIN NATH & ROSENTHAL, SEARS TOWER, WACKER DRIVE STATION, P.O. BOX # 061080, CHICAGO, IL, 60606-1080, US

(21) Appl. No.: 10/225,558

(22) Filed: Aug. 19, 2002

Related U.S. Application Data
(60) Provisional application No. 60/312,763, filed on Aug. 17, 2001.

(51) Int. Cl. B05B 5/00

(52) U.S. Cl. 239/690

(57) ABSTRACT

A process for purifying a dense dielectric fluid containing a contaminant comprising applying a plasma to a dense dielectric fluid containing a contaminant at a pressure, temperature, and for a time sufficient to oxidize the contaminant.

This application claims the benefit under 35 U.S.C. Section 119(e) of U.S. Provisional Patent Application Ser. No. 60/312,763 filed Aug. 17, 2001 and entitled Method, process and apparatus for high pressure plasma catalytic treatment of dense fluids, which application is hereby incorporated by reference.

### BACKGROUND OF THE INVENTION

The present invention relates in general to the treatment or purification of high-pressure gases, liquids and supercritical fluids, collectively termed dense fluids herein. More specifically, the present invention relates to an apparatus and process for in-line or point of use treatment of gaseous, liquid and supercritical carbon dioxide. However, many other high-pressure fluids may be treated using the present invention including nitrogen, argon, air and oxygen, wastewater, chemicals, among others. Growing concerns over organic volatile and non-volatile impurities present in commercial supplies of carbon dioxide, such as oils, sulfur, aldehydes, fluorocarbons, prevent more widespread use of carbon dioxide in cleaning processes, high quality beverage carbonation and critical medical treatment applications.

The CO₂ cleaning technology developed by the present inventor, and described in detail under issued and pending patents, requires unique process fluid supply requirements not found in conventional CO₂ cleaning technology. For example, the TIG-Snow cleaning process described in U.S. Pat. No. 5,725,154, Jackson, teaches the use of both a pure gas and pure liquid carbon dioxide to produce a sonic cleaning spray—a snow component (condensed liquid phase) and a propellant component (expanded liquid phase). Propellant gases may include nitrogen, carbon dioxide or clean-dry-air, among others, and come from a variety of cylinder sources and pressures ranging from 50 psi to 1500 psi. Liquid carbon dioxide is stored under pressure and comes in two forms—300 psi and 0 F (Vacuum Dewar) and 832 psi and 70 F (High-pressure Cylinder). Depending upon the type of cleaning application, various qualities of process fluids may be required to prevent the transfer of contaminants contained within the supply onto critical surfaces during CO₂ spray cleaning operations. Contaminants typically found in CO₂ and other gaseous process fluid supplies include trace hydrocarbons, silicones, and particles. Moreover, common to most CO₂ cleaning applications, regardless of the specific phase used, is a requirement for ultra-pure process gas such as nitrogen and clean dry air for purging and drying operations.

The conventional approach to providing pure CO₂ process fluids is characterized by patchwork and customization. For example, CO₂ cleaning processes can be supplied with cylinder gases and liquids. Cylinders containing ultra-pure process fluids are available from most large industrial gas supply companies. These types of pure fluid supplies are expensive and not available in large quantities. Moreover, bulk supplies of ultra pure process fluids produced on-site with thermal catalytic treatment units and pumps may be installed but are expensive and utilize significant floor space. The cost to deliver this quality of process fluid supply in bulk form makes the CO₂ cleaning process prohibitively expensive. Finally, thermal catalytic treatment units pose a fire hazard due to the very high operating temperatures—as high as 750 C—and cannot be used to treat liquid phase carbon dioxide directly without effecting a phase change. An example of one such commercial CO₂ purification system is offered by Va-Tran Systems, Chula Vista, Calif., which employs a refrigerant-based vapor condenser system. The system may be coupled with a thermal catalytic treatment unit upstream prior to vapor condenser unit to deliver a purified liquid CO₂ product. Problems observed by the present inventor and end-users of this type of purifier when used with aforementioned snow cleaning equipment developed by the present inventor include erratic pressure and temperature regulation of the purified process fluid delivered to the cleaning system and the need to cool the hot treated gas stream prior to liquefaction. Pressure, temperature and delivery control problems become more severe when using this purification device with low-pressure carbon dioxide supplies such as a bulk 300 psi and 0 F tank. Moreover, the conventional catalytic process used fails to fully treat fluorinated organic contaminants.

The closest known art to the present invention known by the present inventor is Chao et al, U.S. Pat. No. 5,370,740, which teaches a process for sonicating liquid carbon dioxide to destroy organic chemicals removed from a substrate. The substrate is first cleaned with a supercritical fluid and then the dirty cleaning fluid is mixed with an oxidizing chemical and hydrogen gas and subjected to acoustic radiation. The drawbacks of this approach are that multiple sonicators are required and dangerous liquid chemical oxidizers and quenchers must be injected into the sonicated stream to complete the treatment reaction. The process of '740 is not capable of creating significant quantities of oxidants in-situ using only small quantities of oxygen gas and water, and does not teach the physicochemical enhancement of oxidative reactions which occur when the acoustic energy is applied to a liquid-solid interface of reactive or catalytic particles, as does the present invention.

More recently, an alternative pollution treatment technology has emerged—the use of high voltage electricity to produce ambient and low-pressure plasmas, which initiate the creation of short-lived oxidative by-products and in turn destroy organic species in water vapor. Plasma treatment methods are receiving widespread attention in industry due to the energy efficiency and relative ambient temperature of this oxidative process. Destruction of organic species in water and air, as well as destruction of concentrated organic streams, using an electrically generated or microwave generated plasma have shown great promise in destroying unwanted organic pollutants. Another technique is the use of a low-pressure plasma wherein a gaseous wastestream is fed into a vacuum plasma chamber with various gases and oxidatively destroyed. Low-pressure plasmas are fairly easy to generate using a variety of energy sources including high voltage and microwave fields. Another such technique is the use of atmospheric plasma or corona wherein a gas or a gas/water mixture is fed into a reaction cell and a high voltage is applied, typically at fairly low frequencies, to the feedstream. This process has been shown to effectively treat various organic compounds under low or ambient pressure and temperature conditions using low frequency—high voltage generators. For example Heath et al, U.S. Pat. No. 5,254,231 teaches using a low frequency (50/60 Hz) plasma discharge in combination with gas bubbling within a bed of particles to create spark discharges in solution to decompose or alter fluids in a continuous flow. In an article entitled “Destruction of VOC's by combination of corona discharge and catalysis techniques”, M. Malik et al, September 1998, Journal of Environmental Sciences teaches the use of a double DC power generator at high power (45 KV) and low frequency 50-120 Hz and under ambient pressure and temperatures to destroy volatile organic compounds (VOCs) passing through a bed of alumina particles. Still another approach uses a low frequency AC power generator.

One major drawback when applying these conventional corona generators and techniques to high-pressure process fluid systems is that the energy density created is directly proportional to the ability to breakdown the molecules into excited molecules, electrons and radicals—hence the formation of a plasma. It has been discovered that conventional corona fluid treatment technologies using the traditional low to medium frequency generators do not work with high-pressure process streams such as gaseous, liquid and supercritical carbon dioxide. This is due to the very high cohesional energies at elevated pressures and temperatures of the present invention. The frequency of the applied electrical energy must be much higher, as much as 10⁴ greater, than conventional high voltage generators in order to achieve and maintain an effective plasma within high-pressure gas, liquid or supercritical carbon dioxide.

The aforementioned processes are termed Advanced Oxidation Processes (AOP's) with the aim of producing strong oxidizers in-situ. The oxidizing power is reflected by the standard reduction potential. The potential is defined relative to the standard hydrogen electrode potential. The Gibbs free energy change of the redox-reaction is calculated from the resulting electromotive force of both half-cell reactions corrected for activity dependence (E), the number of electrons involved (n) and the Faraday constant (F=96485 C/mol). One of the strongest oxidizers known is xenonfluoride (XeF), but this oxidizer is not commercially attractive for process fluid treatment because of both extreme reactivity and remaining toxicity in reduced form. It is obvious, that metal-based oxidizers like permanganate (MnO₄) and dichromate (Cr₂O₇²⁻) also are not desirable. Oxygen-based halogen/metal-free oxidizers like the hydroxyl radical (OH), atomic oxygen (O), ozone (O₃) and hydrogen peroxide (H₂O₂) are more environmentally friendly and are powerful oxidation treatment agents.

The discharge of electric energy into a dielectric medium causes dissociation, ionization and excitation of the dielectric molecules or atoms. Depending on the energy input, the produced plasma is non-thermal or thermal. In thermal plasmas the ionization level is high. Examples of thermal electrical discharges are lightning and arc discharges. Typical numbers of electron density (Ne) and electron energy (Te) for lightning discharges are about Ne=10¹⁷ cm⁻³ and Te=2.2 eV (corresponding to 25000 K). Corona and glow discharges are non-thermal plasmas. Their ionization level is very low, about 10⁻⁶. The electron density of a corona plasma is about Ne=10¹³ cm⁻³. The chemical reactivity of corona discharges is based on the fact that the electric field strength at the discharge streamer heads is extremely high—about 200 kV/cm. This implies an average electron energy of about Te=10 eV, which reaches beyond the dissociation energy of water (5.16 eV); oxygen (5.17 eV) and nitrogen (9.80). Within the energy distribution of electrons in the streamer head, even higher energetic electrons exist that cause ionization of oxygen (12.07 eV), water (12.62 eV) and nitrogen (15.58 eV). A very particular advantage of corona discharges is that a highly reactive streamer discharge medium is created, while the bulk gas remains essentially at ambient temperature and pressure (70 F and 1 atm). Therefore, corona treatment of low-k fluids such as dense phase carbon dioxide offers much higher efficiency than many other advanced oxidation processes—including acoustics.

For example, a study was performed in 1997 to examine alternative treatment processes for hazardous organic wastes, entitled “Evaluation of Nonflame Technologies for Destruction of Hazardous Organic Waste”, Martin Idaho Technologies Company et al, April 1997. Liquid corona treatment using a low frequency discharge over aqueous wastes containing organic contaminants was found to have several advantages including the ability to produce in-situ highly reactive species, no requirement for adding reactive chemicals, and a broader range of contaminant destruction capabilities. However, the referenced study also cited the immaturity of corona based treatment technology.

Corona discharge in the presence of water vapor produces hydroxyl radicals, hydrated electrons, and hydrogen atoms from the dissociation and ionization of water molecules. Corona discharge additionally creates radicals, ions and metastables from the dissociation and ionization of the gas phase molecules or atoms. With trace oxygen gas present in most low-k fluids, or which may be purposely inoculated therein, oxidizer species are produced: hydroxyl radicals, ozone, atomic oxygen, singlet oxygen and hydroperoxyl radicals.

Another AOP is glow discharge plasma (GDP), which creates a cold plasma in contact with the vapor phase above a grounded body of water. Like corona discharge, GDP is a nonthermal plasma and is characterized by having very energetic (“hot”) electrons while the bulk of the molecules are still near ambient temperatures. It forms oxidizing radicals such as OH and O via electron impact, which can react with the contaminant directly or react to form other oxidizing species. These active species react with contaminants dissolved in the aqueous solution an result in. Additionally, GDP also forms reductants such as atomic hydrogen, H, and “solvated” (hydrated) electrons. These active reducing species can provide alternative (reductive) destruction pathways for organic compounds such as carbon tetrachloride, perchloroethylene, dichloroethane, chloroform, etc, which are difficult to oxidize. Dissociative electron attachment has been identified as the major pathway for destruction of carbon tetrachloride, CCl₄, by nonthermal plasma. The nonthermal plasma of a glow discharge occurs in the gas phase between two high voltage electrodes, separated by a dielectric medium such as air. The process occurs under mild vacuum (50-200 Torr) with an electrode gap of ˜1 cm. Under these conditions, partial breakdown of the dielectric medium takes place at approximately 2000 volts and the discharge spreads from the high voltage electrode to the surface of the counter (ground) electrode. When the ground electrode is submerged in water, the discharge extends to the surface. This type of plasma discharge process has been described as glow discharge electrolysis.

Finally, another AOP is called electro-hydraulic discharge (EHD) treatment. An EHD process uses a pulsed arc discharge to create a thermal plasma. The arc is submerged in water under atmospheric pressure and flashes the water to steam so rapidly that a large amplitude shock wave is created. The basis of EHD's chemical destruction has been debated but the most reasonable mechanisms are due to intense UV photolysis and thermal degradation in the immediate vicinity of the arc.

To date, plasma research has been focused on the development of plasma or electrically-based treatment methods for treating polluted water or organic contaminants under vacuum or ambient pressure and temperature conditions. There has been no known research and development of high-pressure plasma or using high frequency electrical energy activation techniques for pressurized fluid systems such as liquefied gas, supercritical fluids or high-pressure gases (Dense Fluids).

However, it has been discovered by the present inventor that high frequency-derived plasma offers significant energy efficiency and performance benefits for dense fluids, especially when coupled with activation energy lowering adjuncts such as catalytic solids and sound energy. As such, there is a present need for an efficient, low cost and effective point-of-use or in-line treatment technique which produces ultra pure carbon dioxide and other process fluids used under elevated pressures and temperatures.

### SUMMARY OF THE INVENTION

The present invention is a novel application of plasma treatment technology for treating (purifying) highly pressurized dielectric fluids such as carbon dioxide, nitrogen, compressed air and other high-pressure fluids. The present invention is a method, process and apparatus for treating in-line or in-situ pressurized dielectric fluid systems using a high-pressure plasma providing a simple, low cost, low energy and in-situ treatment capability for purifying pressurized dielectric fluids. The present process can be maintained at a relatively ambient temperature or may be performed at elevated bulk reaction temperatures. The present invention may be used, for example, to purify gaseous, liquid or supercritical carbon dioxide gas with pressures and temperatures ranging, for example, from 50 psi to 2500 psi and −20 C to 300 C, respectively. The present invention produces ultra clean high-pressure gases, liquids or supercritical fluids for applications such as carbon dioxide cleaning, beverage carbonation and medical device treatments.

A first embodiment of the present invention disclosed herein employs an AOP wherein a pulsed or continuous high voltage and high frequency electrical discharge is applied through a dielectric barrier and into a static or flowing stream of high-pressure gaseous, liquefied or supercritical fluid, forming a high energy plasma therein. It has been discovered that a very-high frequency energy (i.e., 500 KHz) can produce a high-pressure plasma at input voltages of 5 KV or greater. High frequency electrons efficiently overcome the very large cohesional energies present in high-pressure process fluids. High frequency discharges tend to have very noisy voltage curves, which enhance the creation of a non-uniform plasma or corona. However, the present invention is not limited to any particular type of corona plasma generator nor any specific voltage or frequency, other than the frequency must be rather high (i.e., >50 KHz) and voltages greater than 5,000 volts in order to produce a strong enough electric field capable of producing a high-pressure plasma. This high-pressure plasma generates very high energy (“Hot”) electrons which directly oxidize or mineralize the organic contaminants present in the high-pressure fluid. High-pressure plasma electrons produce short-lived but highly oxidative reactants such as ozone gas, supercritical ozone (Pressures>55 atm), hydroxyl radicals, and oxygen radicals from a small amount of water and oxygen, usually present as impurities in dense fluid streams. Moreover the process fluid may be modified with small amounts-of gas or liquid reactants. Depending upon the type of gaseous or liquid additive added to high-pressure process fluid—for example water, argon gas, nitrous oxide, hydrogen peroxide, or oxygen—beneficial oxidative reactants can be produced in excess quantity in-situ. These include argon radicals, hydroxyl radicals or nitrogen radicals, which chemically enhance the treatment reactions. Still moreover, the presence of water provides unique treatment pathways through the formation of supercritical water oxidation. Supercritical water oxidation (SCWO) is produced by extreme pressures and temperatures generated within localized and microscopic regions. This is especially the case at solid-liquid interfaces using sono-plasma treatments of the present invention. Since supercritical water is miscible in all proportions with carbon dioxide and other process fluids and can instantly permeate micro porous surfaces of catalyst particles, the organic contaminant oxidation rates and very fast and only limited by the reaction kinetics rather than mass transfer issues. Complex organic molecules are readily broken down into smaller oxygenated species or completely to carbon dioxide, nitrogen and water. In addition metal organics are reduced to metal oxides or salts, which may be precipitated from the treated fluid.

A second embodiment of the present invention teaches a physical enhancement of the high-pressure plasma treatment process using a packed bed reactor comprising various non-conductive solid particles, which serve as sources of reactants and/or catalyze the plasma treatment process. The present invention produces intense ultraviolet radiation within the fluid being treated, which directly irradiates and decomposes organic molecules. However, most importantly, the UV light generated by high-pressure plasma enhances the overall treatment process by forming oxygen, ozone and hydroxyl radicals. The presence of titanium dioxide (rutile), for example, within the plasma region acts to catalyze the formation of energetic electrons through absorption of the UV light being generated by the high-pressure plasma or the presence of activated alumina catalyzes the formation of ozone or supercritical ozone under the influence of an applied electrical field. Moreover the presence of catalytic particles such as, for example, activated alumina, silica gel, titanium dioxide within the-high-pressure plasma region physically enhance the treatment process by providing more favorable molecular orientations for decomposition reactions to occur and interstitial fluid-particle regions which have very high electric field densities.

A third embodiment of the present invention teaches the use of acoustic energy to sonically activate the high-pressure fluid (liquid) at the solid-liquid interfaces of a packed bed reactor to accelerate treatment reactions during plasma treatment-called “sono-plasma” herein. It has been discovered that acoustic energy at, for example 20 KHz and 600 watts can be introduced during plasma treatment of liquids. A solid titanium ultrasonic horn applicator, uniquely used as a plasma grounding electrode (cathode), can be applied simultaneously within the high-pressure plasma-enhancing the plasma reaction through the formation of extremely high reaction pressures and temperatures and vapor bubbles at the molecular level and particularly at catalyst particle surface-liquid fluid interfaces. The presence of sound energy at the solid-liquid interface during plasma treatment produces a fluidized bed-exposing fresh solid surface and enhancing reactions through increasing the mean-free-path length of energetic electrons within sonic cavitation bubbles at solid-liquid interfaces.

A fourth embodiment of the present invention teaches adding gaseous or liquid additives to the process fluid feed stream which, in the presence of the high energy plasma or sono-plasma, become highly oxidative reactants, for example supercritical ozone or argon radicals, which further enhance the high-pressure plasma treatment process. These species are powerful oxidants and can, themselves or in combination with plasma or sono-plasma treatments herein, greatly accelerate organic decomposition reactions.

A fifth embodiment of the present invention teaches heating the process fluid and/or mixtures therein prior to or during high energy plasma treatment to enhance oxidative and catalytic reactions. The dielectric properties and/or densities of most materials can be significantly lowered which lowers the energy required to produce a plasma. Moreover, plasma catalytic reaction rates are increased through the addition of heat.

A sixth embodiment of the present invention teaches pre-treating a dielectric fluid influent using silica gel reverse phase separation. For example, a fluorocarbon impregnated silica gel, is used to remove and concentrate various and trace gas-phase contaminants from a high-pressure gaseous dielectric fluid.

Finally, the present invention can be used, for example, with any type of commercial CO₂ supply (i.e., high-pressure cylinders, and low-pressure mini-bulk or bulk supplies) and having various chemical qualities. However, other dielectric and non-dielectric process fluids have been tested including ethylene glycol, water and mineral oil. The present invention may be used with process fluids having dielectric constants between 1 and 80, pressure ranges of between 3 atm and 300 atm, and temperatures of between −20 C and 350 C, and phases including gas, liquid and supercritical.

The novel features of the present invention are summarized as follows:

1. High reactor pressures and temperatures favor energetic oxidation reactions and the formation of supercritical ozone and supercritical water. The present invention may be operated on process fluids having pressures ranging from 3 to 300 atm and temperatures ranging from −20 C to 350 C.

2. High-pressure plasma reactors described herein are designed as in-line plug reactors (plasma plugs) and coaxial tubular reactors (plasma tubes) with optional cathodic acoustic horns.

3. Packed bed reactors (PBR) serve as dielectric barriers, electric field concentrators, and catalytic surfaces for high-pressure plasma and sono-plasma reactions described herein. PBR materials include pure or metal-impregnated activated alumina, barium oxide, titanium dioxide (rutile), silica gel, glass, ceramics and zeolites having various particle sizes and porosities.

4. Pulsed and continuous high frequency DC power at high voltage produces dense electron concentrations in gas, liquid or supercritical fluid phases. High frequencies may range from 50 KHz to 4 MHz and voltages may range from 1 KV to 250 KV. A novel pulsation technique employed in the present invention allows the reactor to pulse and reverse phase simultaneously.

5. Gas additives such as Argon, Nitrogen, Oxygen, Nitrous Oxide, Water, Hydrogen Peroxide, when added into the process fluid in quantities of up to 25,000 ppm, serve as chemical adjuncts through the formation of excited gas radicals, hydroxyl radicals, hydrated electrons and supercritical ozone and supercritical water.

6. The plasma or sono-plasma reactor and process fluid(s) may be heated to temperatures of up to 350 C to accelerate plasma decomposition reactions described herein.

7. The addition of acoustic energy in the frequency range of between 20 KHz to 500 MHz and power levels of up to 5000 watts greatly accelerates solid catalyst-liquid reactions during plasma treatment and allows for direct plasma treatment of high dielectric constant fluids such as liquid water.

8. The present invention produces an energy efficient mixture of various physicochemical treatment phenomenon including ultraviolet radiation, wet and dry oxidation, acoustic radiation, and catalysis, creating supercritical treatment conditions which favor very energetic and rapid decomposition of organic species dissolved or entrained within various high-pressure process fluids. These process fluids may have-dielectric constants ranging from 1 to 80 and phases including gas, liquid and supercritical.

### BRIEF DESCRIPTION OF THE DRAWINGS

The features and advantages of the present invention will become apparent from the following detailed description of a preferred embodiment thereof, taken in conjunction with the accompanying drawings in which:

FIGS. 1a, 1b, 1c and 1d are schematic diagrams of the experimental test apparatuses used to develop and test the plasma and sono-plasma treatment methods and processes described herein.

FIG. 1e and 1f and schematic representations of the electrical field lines in a plate type and a coaxial type plasma reactor electrode system, respectively.

FIG. 1g is a chart showing typical impurity constituents found is commercial grade liquid carbon dioxide.

FIG. 2 is a schematic diagram showing the various features of an exemplary high-pressure plasma treatment system using a plate style plasma reactor design.

FIG. 3 is a schematic diagram showing the exemplary high-pressure plasma treatment system employing an in-line coaxial plasma reactor design.

FIGS. 4a and 4b are schematic diagrams of the exemplary sonochemically enhanced high-pressure plasma treatment process.

FIG. 5 is a schematic diagram and graph showing the relationship between the purification rate as it relates to energy inputs, gas additives and packed bed reactor particle type.

FIG. 6a is a schematic diagram of the exemplary high-pressure plasma treatment system showing pressurized process fluid supplies, additives, treatment energy enhancements, gas-phase pretreatment system, and shown with exemplary pure gas applications—solid carbon dioxide spray cleaning and beverage carbonation.

FIG. 6b is a schematic diagram of the exemplary high-pressure sono-plasma treatment system showing pressurized process fluid supplies, additives, treatment energy enhancements, gas-phase pretreatment system, and shown with exemplary nitrous oxide additive injection system.

### DETAILED DESCRIPTION OF A PREFERRED EMBODIMENTS

It has been discovered by the present inventor that applying a continuous, or more preferably a pulsed, high frequency (HF) and variable high voltage (HV) discharge through a high-pressure dielectric barrier reactor containing high-pressure gaseous or liquid carbon dioxide (50 psi to 1500 psi) produces continuous or pulsed high-pressure plasma, respectively. Pulsing is believed to be advantageous in corona treatments because it prevents the formation of ions and promotes the generation of free electrons. Moreover, pulsing and phase shifting used within the present invention prevents electrode arcing or dielectric breakdown. Although pulsing (turning HF-HV generator on and off) was performed using a main power on/off footswitch in this test, this operation can be performed automatically and with pulse duration and phase control using a rotary spark gap similar to an automobile spark distributor. Pulsing is also beneficial in preventing electrode arcing and excessive heating of the catalytic bed and process fluid.

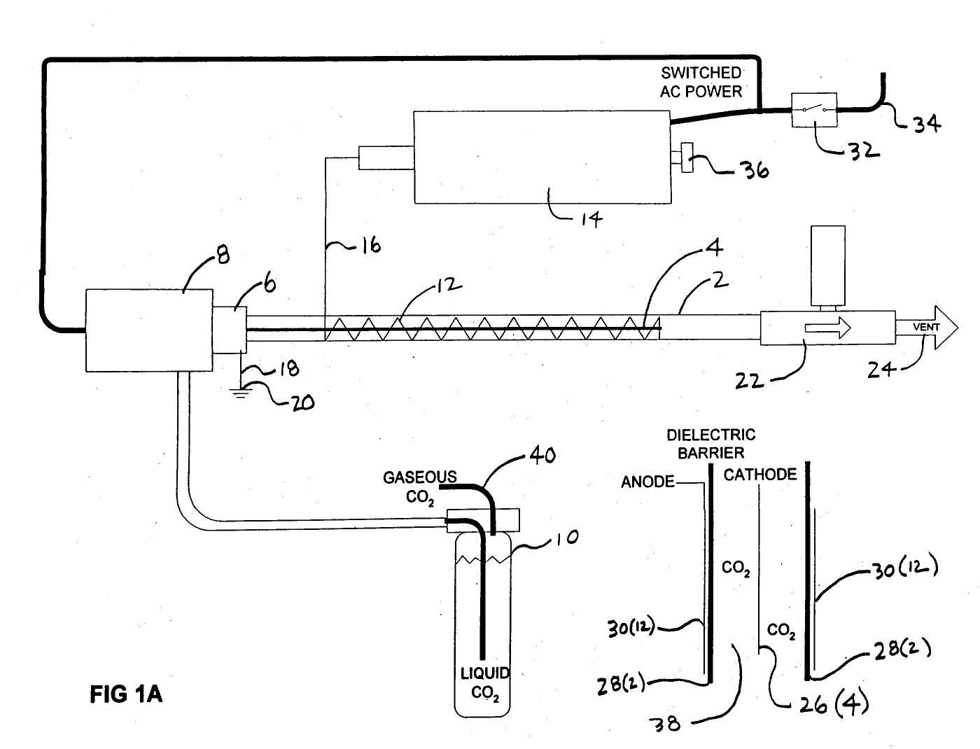

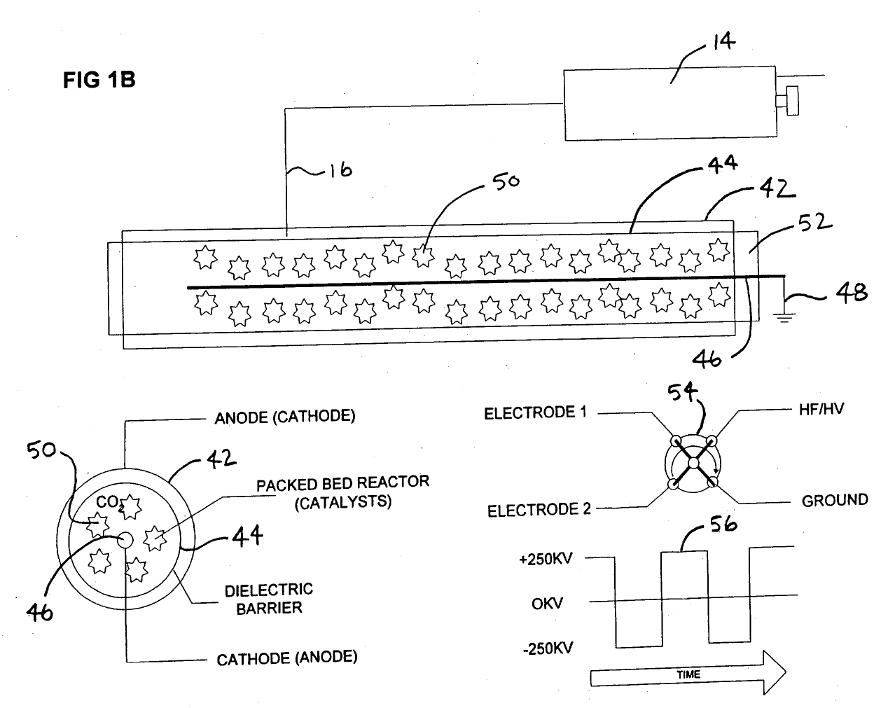

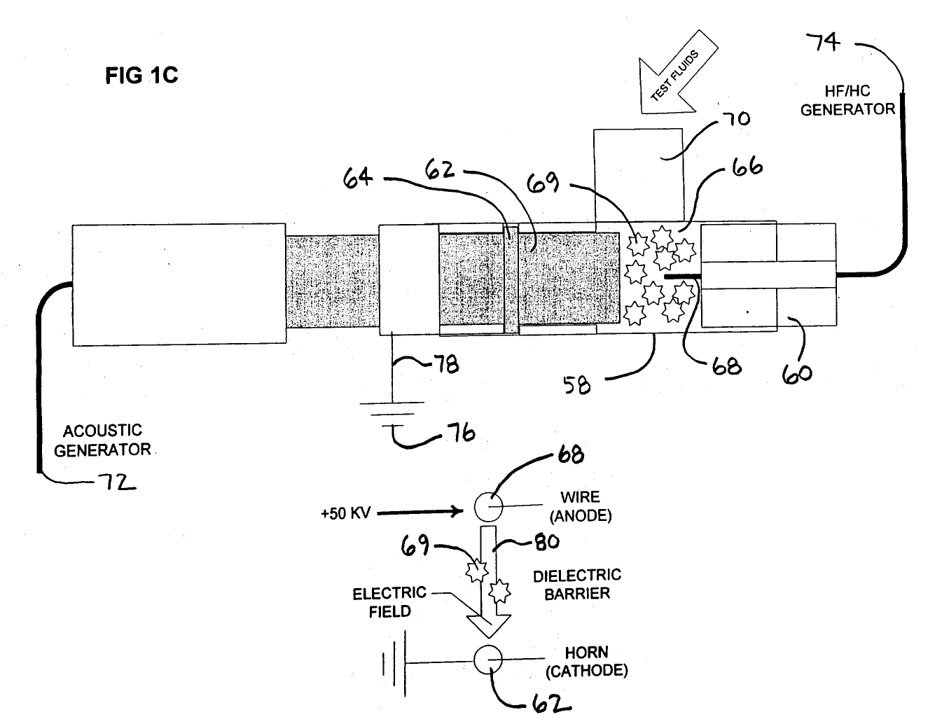

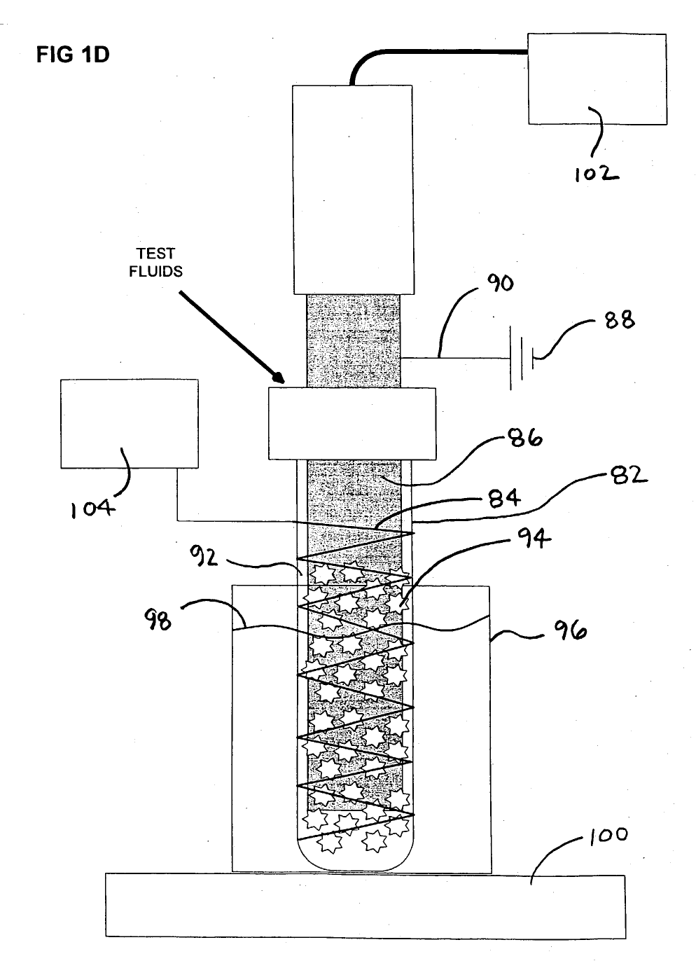

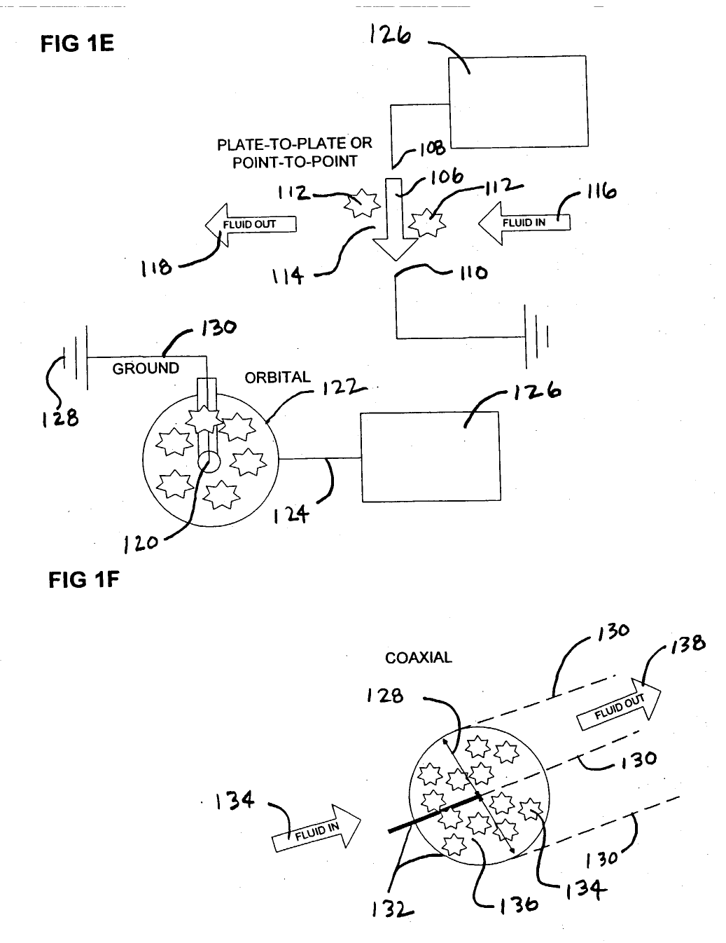

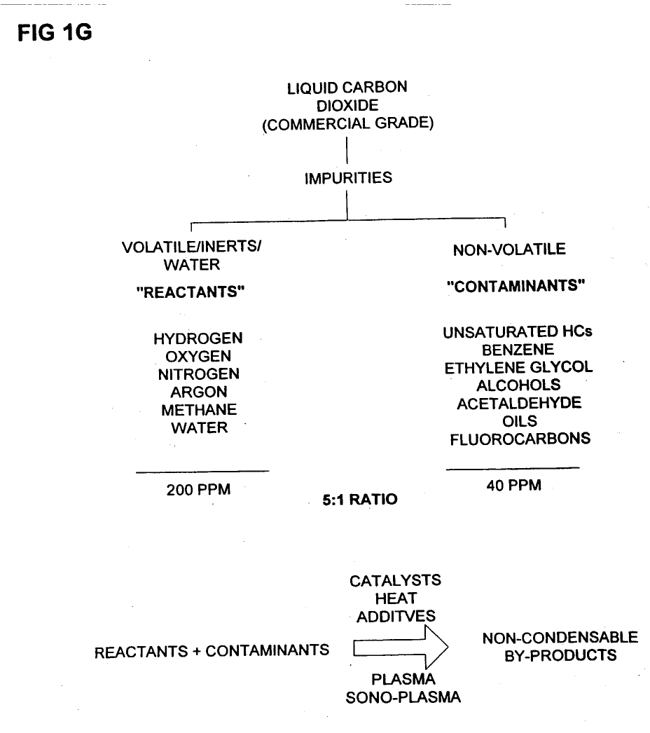

As shown in FIG. 1a, an experimental flow-through test apparatus was constructed using a hollow high-pressure polyetheretherketone (PEEK) polymeric high-pressure tube (2), available from UpChurch Scientific, Seattle, Wash., containing a 1/32 inch stainless steel wire electrode (4) which traversed the entire length of the PEEK tube (2). The internal wire electrode (4) was attached internally to a stainless steel compression fitting (6) on one end of the PEEK tube (2), which was connected to a electric valve (8) and to a supply of high-pressure liquid carbon dioxide (10). A tightly fitting stainless steel spring electrode (12) was placed over the outside of the PEEK tubing (2), acting as a dielectric barrier, making sure that the spring electrode (12) did not touch the grounding fitting (6) on the end of the tube (2). The spring (12), acting as an anode, was attached to a high voltage-high frequency power source (14), available from ETP, Inc., Chicago Ill., Model BD-10A, having a fixed high frequency of 500,000 Hz (500 KHz) and a variable voltage output of between 5,000 Volts (5 KV) and 50,000 Volts (50 KV) using a 12 gage insulated connection wire (16). A bare copper ground wire (18), acting as a cathode, was attached to the fitting (6) and connected to an earth ground (20). On the other end of the PEEK tubing (2), a micro metering flow control valve (22) was affixed which variably controlled the flow of liquid carbon dioxide (10) through the PEEK tube (2) and into the atmosphere (24).

Thus, as shown, the internal stainless steel wire (4) served as the cathode (26), the PEEK high-pressure tube (2) functioned as the dielectric barrier (28), the spring (12) served as the high voltage-high frequency power anode (30). Finally, a footswitch (32) was attached to a 110 V power source (34) and connected to the power supply (14) and electric fluid valve (8).

A dry run was performed without the presence of the dielectric fluid—under atmospheric conditions. It was found that a plasma could be created quite easily at the lowest power adjustment—5 KV, with the intensity of the plasma clearly visible through the PEEK tubing wall and the intensity varied with applied power. The internal grounding wire electrode (4) could be seen to glow through the walls of the PEEK tubing (2). Moreover, a strong smell of ozone was evident.

Following this, the micro metering valve (22) was closed and the liquid carbon dioxide supply tank (10) valve was slowly opened. The micro metering valve (22) was opened to allow the PEEK tube (2) to fill with liquid carbon dioxide. Upon filling the PEEK tube (2) with liquid carbon dioxide at 832 psi, and while the liquid flowed continuously through the test reactor at approximately-5 pounds/hour, the voltage to the plasma test reactor was increased to approximately 10 KV using a power control adjustment knob (36) whereupon an internal high-pressure plasma was visible and audible as noted earlier. At 50 KV of applied power, the plasma intensity increased, evidenced by an increased output of UV light through the PEEK tube (2) wall and an increase in the sound of energetic corona breakdown cavitations. The plasma was produced in the region (38) between the cathode (4)(26) and the dielectric barrier (2)(28). One conclusion from this initial test was that the voltage threshold to create plasma under high-pressure liquid conditions was much higher than under ambient dry run test conditions. Also, the intensity of the plasma did not seem to be affected by the flow rate of liquid carbon dioxide.

A second test was performed as above using gaseous carbon dioxide (40) at 832 psi. A plasma was created between 5 KV and 10 KV. As such, another conclusion was that less energy was required to create a high-pressure plasma within gaseous carbon dioxide present within the plasma region (38) as compared to liquid carbon dioxide-probably due to the significant density differences between the two phases. This was also evidenced by more bulk heating within the—liquid phase-plasma. After several test runs, the high-pressure PEEK tube (2) wall became physically damaged by the intense plasma and ruptured. Moreover, the bulk temperature of the process test fluid (liquid carbon dioxide in this case) within the plasma region (38) increased during plasma treatment when there was no flow through the test cell. This is indicative of conversion of electrical energy into thermal energy (photons, sound and molecular vibration) within the plasma region (38) and the ability of the process test fluid to provide heat extraction.

Referring to FIG. 1b, a second test apparatus was constructed and tested to produce an alternative stainless steel high-pressure reactor, which could withstand the intense plasma field. A section of high-pressure stainless steel tube (42), acting as an anode, was constructed with an internal glass tube (44), acting as a dielectric barrier, within which was placed a long stainless steel wire (46), acting as a cathode, which was connected to earth ground (48). The test apparatus as shown was similarly connected to a HF/HV generator (14) using a connection wire (16) and footswitch power pulsing device (not shown).

A second purpose of this test apparatus was to determine if the plasma generation process could be achieved by reversing the power electrode and dielectric barrier as constructed in the test apparatus of FIG. 1a. As was expected, this test apparatus yielded very similar results as the test apparatus and procedures of FIG. 1a. However, this apparatus did not physically fail after over 40 hours of operation. Moreover, an inspection of the interior surfaces of the tube (42) revealed no noticeable defects or damage to the interior high-pressure stainless steel tube walls. Also this second test apparatus was filled with a variety of dielectric solids (50) including silica gel, activated alumina, glass beads, titanium dioxide, and activated carbon particles to determine if and how plasma is created within a packed bed interior. All materials tested with the exception of activated carbon produced plasmas. As with the test apparatus of FIG. 1a, carbon dioxide gas was passed through the interior region (52) of the plasma reactor.

A conclusion of this study was that a variety of non-conductive catalytic solids, which do not ground the electric power to the ground electrode during activation may be used. Moreover, the dielectric particles appeared to collect electric charges and discharge similar to capacitors, evidenced by inter-particle sparking. As such, a multiplicity of hydrophobic and hydrophilic zeolites, catalysts and other solids and mixtures thereof may be used as packed bed reactor materials with the present invention. These catalysts may contain traces of heavy metals such as cobalt, palladium, chromium, nickel, iron or platinum which serve specific catalytic structures for various hydrocarbon treatments (i.e., Fluorocarbons) or may serve as adsorbents or cages. For example, the use of silica gel can be used to selectively absorb moisture from the process fluid being treated, which is then available as a solid-phase reactant during plasma or sono-plasma treatments to produce powerful hydroxyl radicals and solvated electrons. Moreover, the process fluid to be treated may be deliberately spiked with a small amount of water or hydrogen peroxide for this purpose.

Finally, reversing the cathode and anode circuit also produced a plasma, confirming that the direction of the plasma stream could be reversed-within-a packed bed reactor. This is an advantageous and novel capability because it allows the plasma reactor to pulse and reverse phase simultaneously, rather than using a conventional voltage pulsing techniques. As shown in FIG. 1b, a variable-speed switching rotor (54), similar to a spark plug distributor, can be used to produce an alternating anode-cathode series. By adjusting the speed of the rotor (54), variably spaced and variably powered plasma energy profiles (56) can be produced within a range of +250 KV to −250 KV using a suitable high frequency power generator (not shown).

As shown in FIG. 1c, a third test apparatus was constructed and tested to investigate the enhancement effects of acoustics used in combination with high-pressure plasma and packed reactor beds filled with dielectric fluids. A grounded stainless steel tee (58) was used to construct a sono-plasma reactor, described as follows. This test apparatus used a custom manufactured single high voltage-high frequency electrode assembly comprising a glass-to-metal seal (60), available from Accratronics Seals, Burbank, Calif., threaded into one port which was opposed to a titanium acoustic horn (62), available from Sonics and Materials Danbury, Conn., and affixed using a sealing flange (64) located on a nodal point along the sonic probe (62) axis and grounded to the tee body (58). The space (66) between the sonic horn (62), acting as a cathode, and HF/HV probe (68), acting as an anode, was filled with activated alumina pellets and titanium dioxide particles (69). The apparatus was tested with the last open port (70) facing upward. The entire internal cavity (66) was filled with mineral oil (dielectric constant (k)=2). The sonic probe (62) was connected to a 20 KHz generator (72) (not shown) and the HF/HV probe was connected to a HF/HV generator (74) (not shown). The stainless steel tee (58) was connected to earth ground (76) using an insulated copper grounding wire (78). Finally, as shown in FIG. 1c the sono-plasma test apparatus was designed to produce an electric field (80) between the HF/HV probe (68) and the sonic probe (62) and through a dielectric bed of catalytic particles (69).

Sono-plasma energy was applied as follows—the acoustic energy was set at 20 KHz and 200 watts with 1 second on/off intervals and the plasma energy was set to run in a power pulsed mode at 500 KHz and 50 KV with approximately 1 second pulse durations using the footswitch device described in FIG. 1a (32). The preferred pulse duration (as well as phase reversal) may range between 10 microseconds and 500 milliseconds, however sono-plasma activation may be performed continuously without phase change or pulsation. During operation, the entire packed bed mixture could be seen to boil or fluidize aggressively with visible UV light and corona discharges seen within the fluid cavity (66) and between the anode (68) and cathode (62). Adjusting the power of both the acoustic horn (62) and HF/HV probe (68) visibly altered the intensity of the treatment reaction. When the acoustic horn (62) was deactivated, both the packed bed fluidization action and plasma intensity reduced significantly. Moreover, during sono-plasma treatment, the clear mineral oil turned to a dark brown color during the testing—an indication of the presence of intense oxidation and decomposition reactions. The conclusion from this testing was that the presence of acoustic energy greatly increases the formation of plasma within a liquid phase reactor due to the formation of millions of microscopic cavitation vapor bubbles within the liquid phase and particularly at the catalytic solid-liquid interfaces within the packed bed reactor and at the acoustic radiator surfaces (anode). Within the high-pressure cavitation bubbles, highly energetic and oxidative microenvironments are being created.

Referring to FIG. 1d, a fourth test apparatus was constructed using a Pyrex (a trademark of Corning, USA) glass test tube (82) over which a stainless steel wire electrode (84) was wound very tightly and held in place using electrical insulation tape (not shown), thus forming an anode and dielectric barrier series, respectively. A titanium horn (86), similar to the type used in FIG. 1c was inserted into Pyrex sheath. The sonic horn (86) was attached to earth ground (88) using a shielded and insulated electrical wire (90), thus serving as the cathode in this test sono-plasma system. The space (92) between the titanium horn (86) and glass dielectric barrier (82) was filled with a 50:50 (vol:vol) mixture of activated alumina and titanium dioxide particles (94). Within this space (92), various fluids were also placed for sono-plasma testing. The entire test cell was placed into a beaker (96) filled with mineral oil which serve a bath. A hot plate (100), available from Coming, Model PC-351, was placed below the beaker (96).

The purpose of this test apparatus and experiment was to determine if a plasma field could be developed and maintained along the entire axis of an activated solid tubular titanium sonic probe (86) while submerged in a low-k fluidized bed of solid catalyst (94) and dielectric fluid (filled void spaces of dielectric fluid) and under a range of operating temperatures, acoustic energy and electrical energy. Water, ethylene-glycol and mineral oil were tested within the plasma region (92) with cavitation energies of between 50 and 600 watts at 20 KHz using an acoustic generator (102) and plasma energies of between 10 KV to 50 KV at 500 KHz using a HF/HV generator (104). In each test conducted with the various fluids at 25 C, a visible plasma with acoustic cavitation was produced within the plasma-region (92)-between the glass tube (82) and the sonic probe (86). This is very advantageous since tubular sonic resonators produce intense cavitation along their entire axis, rather than just at the tip. Following testing with water, a strong smell of ozone could be detected over the treated water.

Additional tests were performed at elevated temperatures of 60 C and 100 C using the hot plate (100) and mineral oil bath (98). In these tests, the sono-plasma treatment appeared to be much more intense with increasing cavitation in proportion to increased temperature. The experimental apparatus and tests confirmed that a sono-plasma field could be generated in all of the process fluids tested having dielectric constants ranging from 2 to 80. It was further concluded that sono-plasma treatment was possible in all of these liquids regardless of their dielectric constants because of the millions of cavitation vapor bubbles produced by the intense sonic energy generated and increasing temperature enhanced the cavitation and plasma reactions. Increasing temperature reduced the power needed for both cavitation and plasma generation.

A more theoretical discussion follows with respect to the experimental tests performed and described above in FIGS. 1a, 1b, 1c and 1d.

FIG. 1e is a schematic showing the direction of the electric field in a point-to-point or plate-to-plate electrode system. As can be seen from the diagram, the plate electrode configuration produces an electric field (106) which is produced at the positive voltage high frequency electrode (108), and pointing to the grounding electrode (110) through a bed of catalytic particles (112) and producing a plasma within the void spaces (114). Untreated process fluids (116) flow into and through the plasma region (114) and plasma treated process fluids (118) out of the plasma region (114). Also shown is an alternative design in which an insulated grounding electrode (120) is positioned at the center of an spherical treatment chamber (122), which is connected using an insulated conductor (124) to a source of high frequency and high voltage power (126). The grounding electrode (120) is connected to an earth ground (128) using an insulated conductor (130). In these point-to-point configurations the energy density is uniform between the electrodes, but is concentrated on the grounding electrode.

FIG. 1f gives a schematic showing the nature of an electric field tubular reactor system. As can be seen from the diagram, the coaxial style electrode configuration has the electric field lines (128) generated perpendicular along the axis (130) with the electrodes (132) in a parallel alignment and through an axial bed of catalytic particles (134). The electric field (128) may be concentrated, depending upon the electrode configuration, along the center electrode (i.e., serving as a cathode), in effect intensifying and concentrating the energy field due to the differences in surface area between the anode and cathode surfaces. In this configuration the electric field energy density is uniform between the electrodes along the entire axis and may be altered by changing the phase between the electrodes as discussed above. As with the point-to-point electrode configuration of FIG. 1e, untreated process fluids (134) flow axially through the interspatial regions (136) wherein the plasma is generated and treated process fluids (138) emerge from the reactor at a predetermined distance downstream. Using this arrangement, long treatment paths can be produced as compared to point-to-point plasma configurations.

FIG. 1g is a chart showing a typical assay of liquid carbon dioxide produced and purified at the source as a by-product of oil refining processes. When purifying carbon dioxide and assigning purity levels (i.e., 99.9999%), it is most appropriate to assign this purity value in relationship to end-use application requirements or more particularly the type of impurity which is desired to be removed. For example, when purifying liquid carbon dioxide for snow cleaning applications—the condensable or non-volatile impurity level remaining following treatment defines the quality of the product. In this regard, the most critical characteristics of liquid carbon dioxide with respect to the snow cleaning are defined as two classes or groups of impurities. As shown in FIG. 1g, the impurities may be classified as volatile (low temperature boiling) and non-volatile (high temperature boiling compounds), also as condensable and non-condensable respectively. The present invention utilizes the volatile fraction, as-well as water, found within commercial grade carbon dioxide to destroy, under the influence of a high-pressure plasma or sono-plasma field, the non-volatile (“contaminants”) fraction contained therein. The resulting by-products of the present treatment process are a mixture of carbon dioxide and volatile (non-condensable) compounds such as argon, nitrogen and carbon dioxide. The water fraction is also converted to hydrogenated and oxygenated compounds in the process or, as discussed in the present invention, retained (caged) within the packed bed reactor (i.e., using a hydrophilic zeolite) as a solid-surface adsorbed resource for subsequent plasma reactions. Moreover, as shown in FIG. 1g, the ratio of volatiles to non-volatiles in the liquid phase favors complete conversion given sufficient reactor energies (i.e., thermal, chemical, acoustic, electronic, mechanical, photonic) and reaction time.

Moreover, the impurities contained in liquid phase represent a worst-case contamination condition. Typically the vapor phase will entrain only a fraction of the liquid phase impurities. Still moreover, impurity compounds such as water form Lewis acid-base complexes in liquid carbon dioxide, which as a result produces a water vapor concentration within the carbon dioxide vapor phase in the low parts per billion range. In contrast to water, contaminants such as fluorocarbons and light gases will be found in equal or higher contamination levels on a molar volume basis within the vapor phase. As such, careful attention must be paid to the availability of reactant impurities to insure that the contaminants are efficiently decomposed. In such cases, the vapor phase may be spiked with small quantities of oxygenates such as gaseous oxygen, gaseous or liquid nitrous oxide or clean dry air and other useful additives such as water or volatile inert compounds such as argon. For example, nitrous oxide can be reacted as a liquid or supercritical fluid oxidizer under reactor pressures and temperatures of the present invention. In another example, argon gas can be used as an energetic plasma gas to assist with organic chemical destruction.

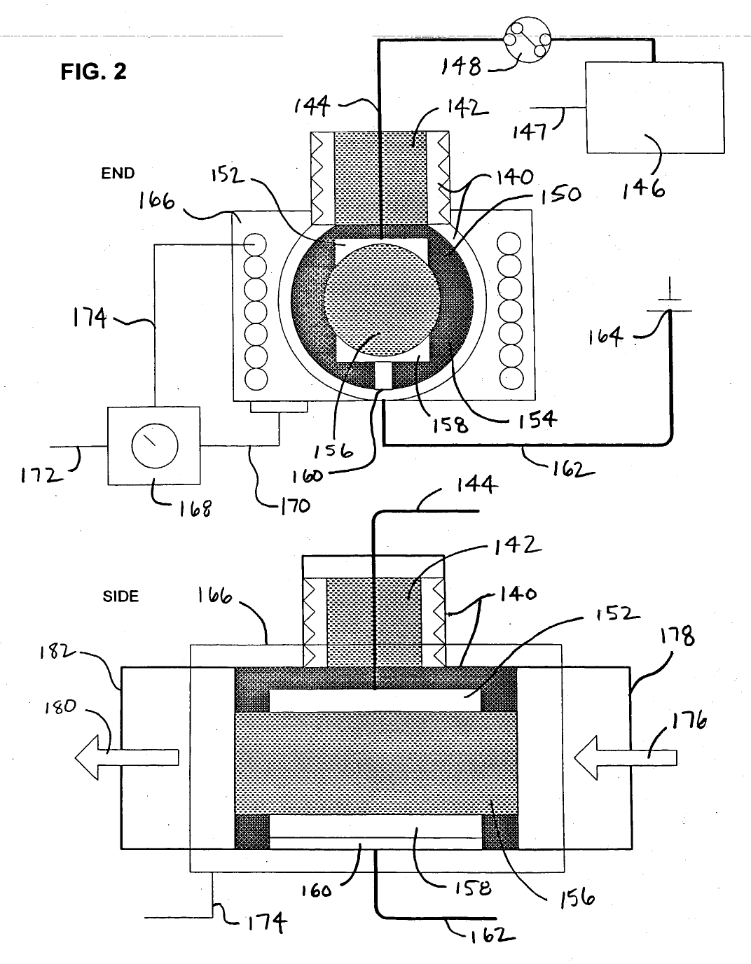

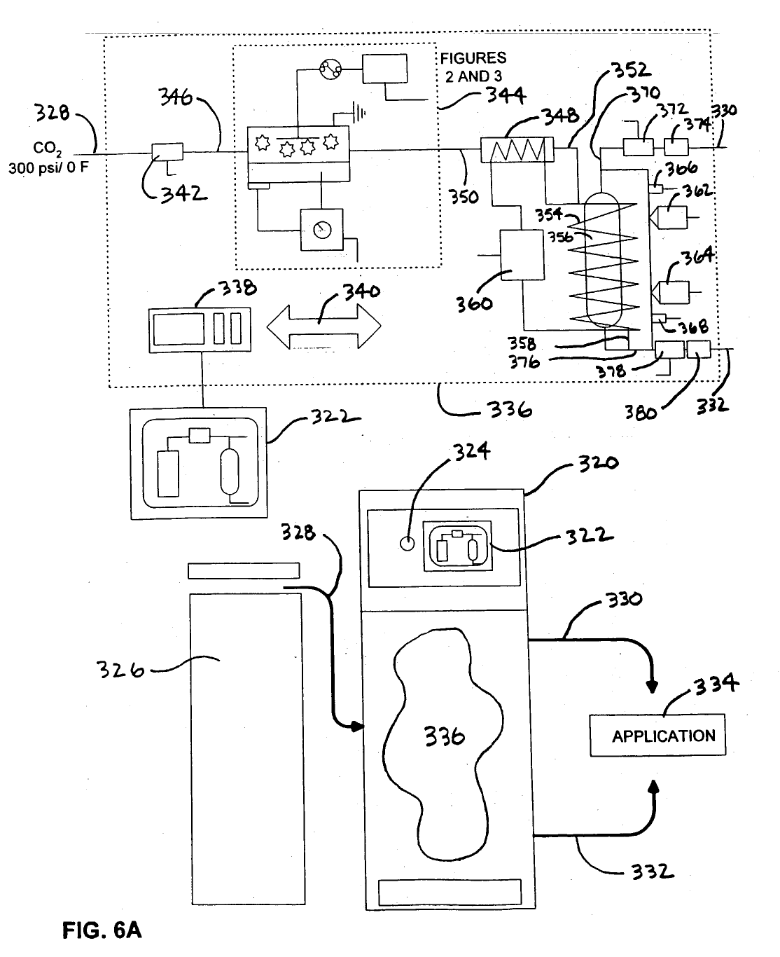

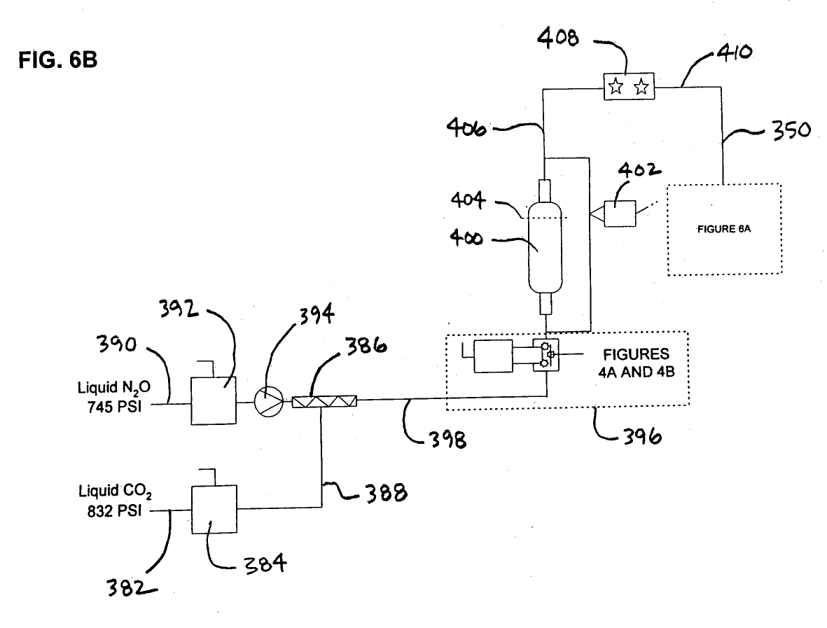

Turning now to a more detailed consideration of the preferred embodiments of the present invention, FIG. 2 is a simple low-cost heated high-pressure plasma treatment cell constructed as a plug reactor using a stainless steel tee. The present high-pressure design is adaptable to in-line treatment of high-pressure gaseous, liquid and supercritical fluid streams. As shown in the end section cut view of FIG. 2, a high-pressure stainless steel tee (140) is having three threaded ports (only one shown) contains a glass-to-metal seal (142) which communicates a high voltage and shielded conductor wire (144) from a source of high voltage-high frequency power (146), with a AC power connection (147) through a pulsation device (148) into the central reactor cavity (150) and is connected to an metallic electrode (152). The internal reactor cavity (150) comprises a ceramic insulator (154) with a centralized porous dielectric plug (156), which is sandwiched between the power electrode (152) and a grounding electrode (158). The grounding electrode (158) is designed to contact the inner wall (160) of the stainless steel tee (140). Thus the plasma reactor is formed between the power electrode (152) and the grounding electrode (158) and within the porous dielectric body (156). The porous plasma reactor plug (156) serves as the dielectric barrier in this design and may be constructed of any variety of catalytic and non-catalytic solids described herein and may include a solid porous cylinder or block of alumina, granular activated alumina, titanium dioxide pellets, heavy metal-doped zeolites, activated silica, mixtures thereof, and other beneficial reactive dielectric solids. The stainless steel tee (140) is connected to a ground wire (162), which is connected to an earth ground (164). The present design also includes an electric heater (166), which is connected to a temperature controller (168), thermocouple (170) and AC power source (172), with temperature-controlled heater power supplied using an output power wire (174). The electric heater (172) can be safely used with the high-pressure stainless steel tee (140) up to a temperature of 250 C using the present design. However, custom machined tees may be produced for higher temperature operation. As shown in the side section cut view of FIG. 2, the plug reactor is operated as follows. Untreated high-pressure process fluids (176) enter an inlet port (178) of the stainless steel tee (140), whereupon the untreated fluid (176), which may contain one or more treatment additives such as oxygen, nitrous oxide, argon, hydrogen peroxide and others, enters a tortuous path comprising the plug reactor bed solids or porous alumina block (156). Within this region, the organic contaminants and reactants contained therein are subjected to high-pressure radicals, ultraviolet radiation, ozone and heat. During treatment, the organic contaminants are degraded into volatile organic compounds, radicals, carbon dioxide and water, which will be discussed for fully using FIG. 6, producing a treated high-pressure process fluid (180) which exits an outlet port (182). Pulsed, continuous or alternating plasma power having a preferred frequency of between 500 KHz and 4 MHz and voltage of between 5 KV and 250 KV may be applied using the current design. The type of dielectric catalytic solids, porosity, distance between power and ground electrodes are adjusted with both frequency and applied voltage to produce a corona plasma without producing arcing (shorting) between the opposing electrode surfaces.

Finally, the design of the in-line plug plasma reactor of FIG. 2 may be constructed of any variety of materials, shapes and sizes provided that pressure, temperature and plasma reaction compatibility-issues are properly considered. Moreover, the present design has a limited retention or treatment zone and is useful predominantly as a polishing step for treating a distilled high-pressure process fluid, for example a high-pressure carbon dioxide gas, prior to condensation into liquid or for use directly following plasma treatment.

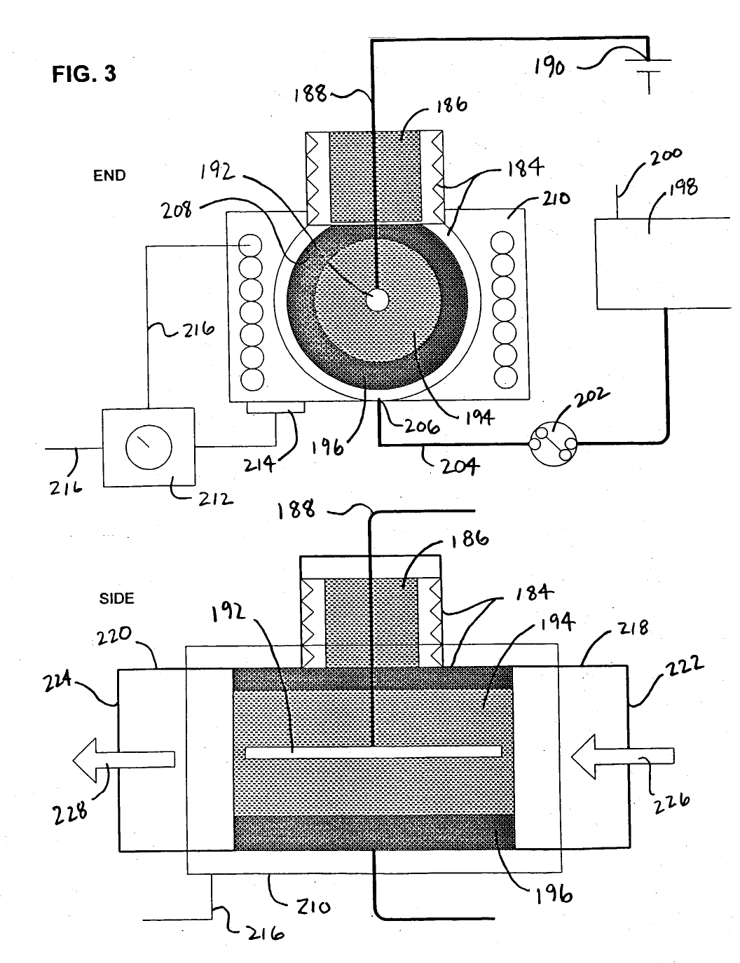

FIG. 3 gives an alternative packed tubular high-pressure plasma reactor. Although similar to the apparatus of FIG. 2, the plasma treatment apparatus of FIG. 3 is a packed tubular or coaxial reactor, which is designed to produce much longer plasma treatment zones, improved turbulent mixing and more complete treatment reactions as compared to the plug type reactor of FIG. 2. The present high-pressure design is adaptable to long in-line treatment of high-pressure gaseous, liquid and supercritical fluid streams. As shown in the end section cut view of FIG. 3, a high-pressure stainless steel tee (184) comprise a middle portion of the coaxial reactor, having three threaded ports (only one shown in the end view) contains a glass-to-metal seal (186) which communicates a shielded grounding wire (188) to an earth ground connection (190). The grounding wire (188) extends into the interior portion of the coaxial reactor and couples with a grounding wire (192). The grounding wire may be constructed using stainless steel wire or rod having diameters ranging from 0.5 to 10 mm and can have a variety of lengths ranging from 1 to 100 centimeters, or more. The grounding wire (192) traverses the entire length of the treatment apparatus and is positioned within the center and is encapsulated within a bed of catalytic solids (194), which itself is contained within a ceramic insulator (196). The body of the stainless steel tee (184) is connected to a source of high voltage-high frequency power (198), powered by an AC power connection (200), through a pulsation device (202) and finally through a shielded high voltage power electrode (152) which is attached to a portion (206) of the stainless steel tee (184). The type of dielectric catalytic solids, porosity distance between power and ground electrodes are adjusted with both frequency and applied voltage to produce a corona plasma without producing arcing (shorting) between the opposing electrode surfaces.

Thus the coaxial plasma reactor is formed between the interior wall (208) of the stainless steel tee (184), serving as the power electrode, and the grounding electrode (192) and within the porous dielectric solids (194). The porous plasma reactor plug (194) and optional ceramic insulator (196) serve as the dielectric barrier in this design and may be constructed of any variety of catalytic and non-catalytic solids, described herein, and may include a solid porous cylinder or block of alumina, granular activated alumina, titanium dioxide pellets, heavy metal-doped zeolites, activated silica, mixtures thereof, and other beneficial reactive dielectric solids. The present design also includes an electric heater (210) which is connected to a temperature controller (212), thermocouple (214) and AC power source (216), with temperature-controlled heater power supplied using an output power wire (216) from the temperature controller (212). The electric-heater (210) can be safely used with the high-pressure stainless steel tee (184) up to a temperature of 250 C using the present design. However, custom machined tees may be produced for higher temperature operation. Moreover, the heater is used as an optional thermal energy enhancement in the present invention and may be turned off when treating liquefied gases—such as carbon dioxide if a phase change (i.e., liquid to gas or supercritical fluid) is not desired within the plasma treatment cavity. As shown in the side section cut view of FIG. 2, the coaxial plasma reactor may be designed with various lengths and diameters of stainless steel tubing. An inlet tube (218) may be connected to one port of the tee (184) and an outlet tube (220) may be connected to a second port. The coaxial reactor cavity comprising the grounding electrode (192), porous reactor bed (194), optional ceramic insulator (196) and heater assembly (210) may be constructed of a variety of lengths and diameters, extending into the inlet tube (218) and outlet tube (220) as desired. Not shown are electrical isolation connections, which are connected to the end section (222) of the inlet tube and the end section (224) of the outlet tube. The isolation connectors may be manufactured using Delrin, Teflon or Polyetherimide, or other suitable high-pressure non-conductors, which isolate the power from adjunct plumbing and systems to the coaxial plasma reactor. Moreover, as discussed above, the central grounding wire (192) may be used as the power electrode and the stainless steel-tee (184) used as the grounding electrode. This is accomplished by switching the circuits as described above using the power source (198) and earth ground (190). Alternatively, a switching circuit as described in FIG. 1B may be used to produce an alternating electrode. The present design operates as follows. Untreated high-pressure process fluids (226) enter an inlet port and coaxial reaction tube (218), whereupon the untreated fluid (226), which may contain one or more treatment additives such as oxygen, nitrous oxide, argon, hydrogen peroxide and others, and enters a tortuous path comprising the plug reactor bed solids or porous alumina block (194). Within this region, the organic contaminants and reactants contained therein are subjected to high-pressure radicals, ultraviolet radiation, ozone and heat. During treatment, the organic contaminants are degraded into volatile organic compounds, radicals, carbon dioxide and water, which will be discussed for fully using FIG. 6, producing a treated high-pressure process fluid (228) which exits an outlet port and tube (220).

Finally, the design of the in-line coaxial plasma reactor of FIG. 3 may be constructed using any variety of materials, shapes and sizes provided that electrode conductivity, operating pressure and temperature and compatibility with reactants and by-products are properly considered. Moreover, the present design has an extended treatment zone and is useful treating high-pressure liquids, gases and supercritical fluids.

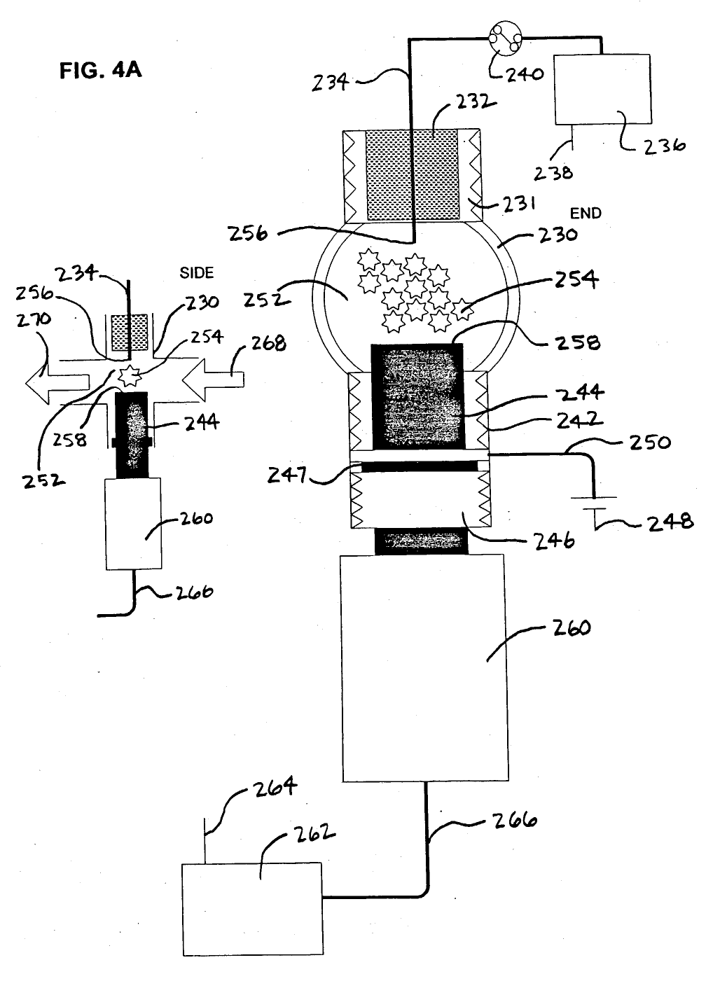

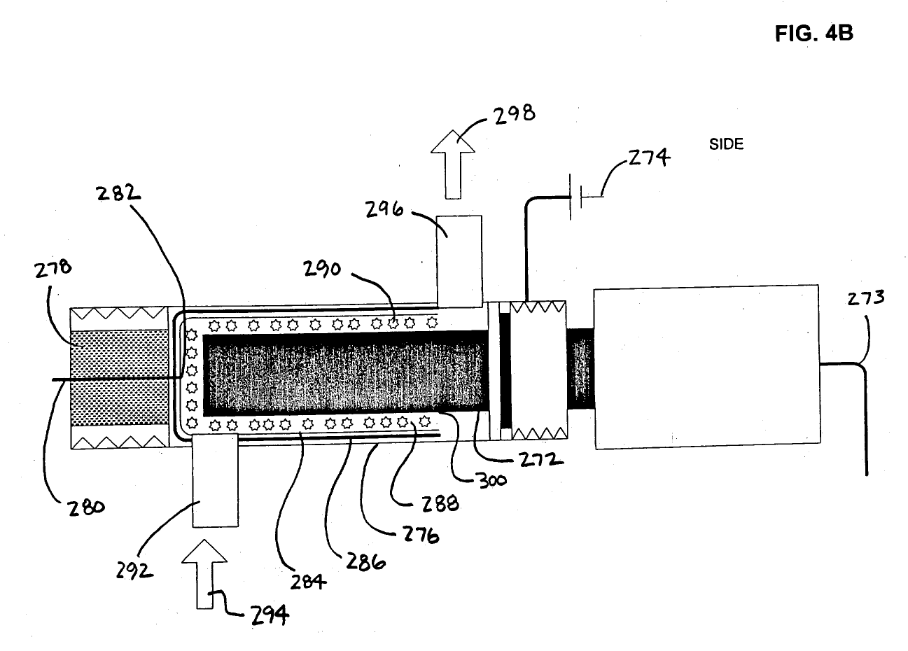

FIGS. 4a and 4b represent alternative acoustic energy enhanced high-pressure plasma reactors for liquefied gas treatment. A sono-plasma reactor design produces a much more aggressive treatment of high-pressure liquid process fluids as compared to the exemplary apparatuses of FIGS. 2 and 3. In this design, a titanium sonic probe serves as both the grounding electrode and a source of intense acoustic radiation during the plasma treatment process. The main difference between these two sono-plasma reactors is the positioning of the dielectric barrier in relationship to the titanium sonic horn and the type of sonic horn being either longitudinal (sound energy produced at one end) or tubular (sound energy produced along the shaft).

Referring to end section view of FIG. 4a, the exemplary longitudinal sono-plasma reactor comprises a stainless steel quad connector (230), which contains four threaded ports with a plasma power port (231) containing a threaded glass-to-metal seal (232) having a shielded power electrode (234). The power electrode (234) is connected to a source of high frequency-high voltage power (236), which is connected to an AC power source (238), and through a pulsation device (240). A threaded sonic port (242) contains a flanged titanium sonic probe (244), which is affixed using a threaded nut (246) and Teflon flat seal (not shown) affixed to the high-pressure side of the probe flange (247). The sonic port (242) is grounded to earth ground (248) using a shielded conductor wire (250). The internal cavity (252) may be filled with a variety of catalytic solids (254) as discussed above in FIGS. 2 and 3. The power electrode (234) may extend into the cavity (252) and porous solids (254) and may be connected to an electrode termination device (256) such as a small stainless steel ball, but should not make contact with the tip (258) of the sonic probe (244). The sonic probe is connected to a transducer assembly (260) which is connected to an ultrasonic power generator (262), which is connected to an AC power supply (264) using a power connection cord (264), using a sonic power supply cable (266).

Pulsed, continuous, or alternating plasma power having a preferred frequency of between 500 KHz and 4 MHz and voltage-output of between 5 KV and 250 KV may be applied. The type of dielectric catalytic solids, porosity, distance between power and ground electrodes are adjusted with both frequency and applied voltage to produce a corona plasma without producing arcing (shorting) between the opposing electrode surfaces. Pulsed or continuous acoustic energy of between 20 KHz and 500 MHz and power of between 100 watts and 5000 watts may be applied.

Referring to the side section view of FIG. 4a, high frequency high voltage electrical power is applied to the plasma electrode tip (256), serving as the power electrode, while ultrasonic energy is generated at the sonic probe tip (258), serving as the grounding electrode. A sono-plasma field is generated within the region (252) between the electrodes which contains catalytic solids (254). Untreated process fluids (268) pass into the sono-plasma reaction cavity (252), whereupon acoustic and plasma energy work in combination with catalysts to accelerate the decomposition o organic process fluid. Treated process fluid (270) exits the sono-plasma treatment cavity and is further treated or used directly.

Referring to FIG. 4b, an alternative sono-plasma treatment system is given, which provides a more extensive treatment of organic contaminants contained within high-pressure liquefied process fluids. As shown in the figure, this accomplished using a transverse titanium sonic horn (272), which is connected to an acoustic power generator through power cable (273) and grounded to earth ground (274) as described in FIG. 4a. In this design, a threaded and ported stainless steel pipe (276) is used to construct the sono-plasma treatment unit. A threaded glass-to-metal seal (278) containing a shielded power electrode (280) is affixed to an opposing port on the stainless steel pipe (276). The electrode (280) is terminated on a dielectric barrier electrode (282), which shrouds the entire titanium probe (272) with a cylindrical power electrode (284). The power electrode (284) is itself shrouded with an electrical insulator (286) such as Teflon, which isolates the power electrode (284) from the stainless steel pipe (276) body. A treatment cavity (288) is thus formed between the grounded sonic horn (272) and HF-HV power electrode (284). Within the treatment cavity (288), various pellet or particle catalysts or a porous hollow cylinder of alumina (290) are placed, thus producing a porous catalytic reaction cavity. An inlet port (292) is used deliver untreated process fluid (294) into the treatment cavity (288) and an outlet port (296) is used to deliver treated process fluid (298) from the treatment cavity (288).

Pulsed, continuous, or alternating plasma power having a preferred frequency of between 500 KHz and 4 MHz and voltage output of between 5 KV and 250 KV may be applied. The type of dielectric catalytic solids, porosity, distance between power and ground electrodes are adjusted with both frequency and applied voltage to produce a corona plasma without producing arcing (shorting) between the opposing electrode surfaces. Pulsed or continuous acoustic energy of between 20 KHz and 500 MHz and power of between 100 watts and 5000 watts may be applied.

Referring to FIG. 4b, high frequency high voltage electrical power is applied to the plasma electrode shroud (284), serving as the power electrode, while ultrasonic energy is generated along the entire axis (300) of the sonic probe (272), serving as the grounding electrode. A sono-plasma field is generated within the treatment region (288) between the electrodes, which contains catalytic solids (290). Untreated process fluids (294) pass into the sono-plasma reaction cavity (288) whereupon acoustic and plasma energy work in combination with the catalysts (290) to accelerate the decomposition of organic compounds contained within the process fluid. Treated process fluid (298) exits the sono-plasma treatment cavity and is further treated or used directly.

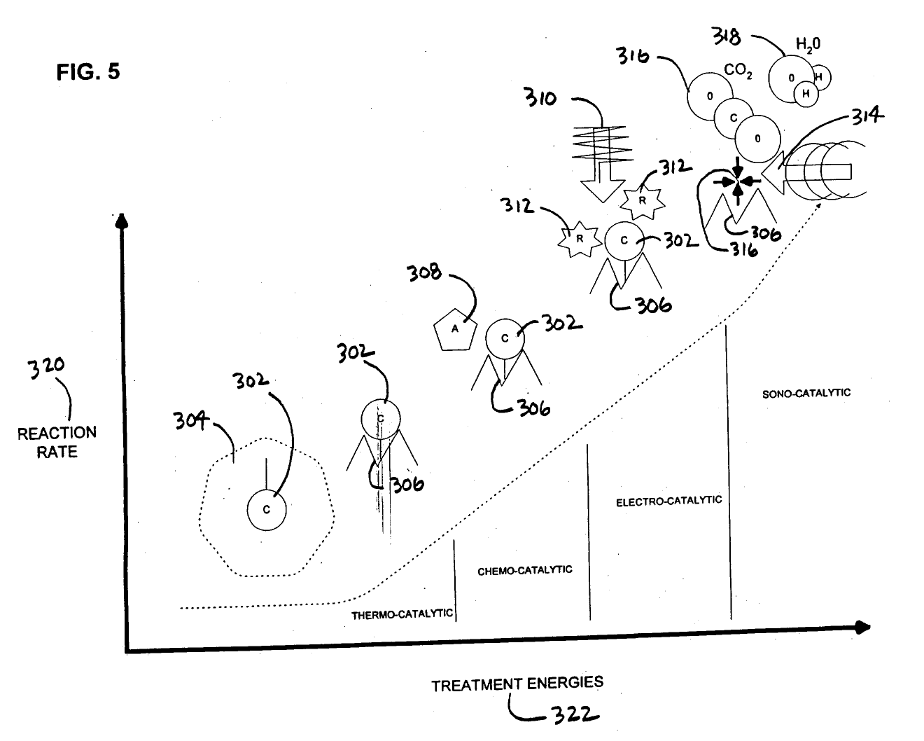

Following is a theoretical treatment of the present invention, showing how the various physical and chemical components work together to produce a scalable process fluid treatment. This is especially beneficial with respect to treating recalcitrant organic impurities such as halocarbons and metal-bearing organics. Referring to FIG. 5, treatment effectiveness as measured by reaction kinetics is optimized in the present invention using thermo-catalytic, chemo-catalytic, electro-catalytic and sono-catalytic phenomenon. Specific process variables discussed herein include applied electrical power (voltage-frequency-phase-pulsation), sonic energy levels (power-frequency-pulsation), temperature, additives (concentration-type), catalysts (porosity-type), contact time (flow rate), and pressure (fluid density and phase). A simplified explanation of the additive effect of the energies and chemistries used in the present invention follows. As shown in FIG. 5, a carbon-containing contaminant (302) such as trace oil is present in a high-pressure process fluid (304) as a dissolved, suspended or entrained constituent. Catalysts or adsorbents (306), and specifically high-surface area pores, are used in the present invention to adsorb or absorb organic contaminants (302), providing proper molecular orientation for thermal degradation of the contaminant (302) on or within the pores of the surface of the catalyst (306), serve as plasma field enhancers (somewhat like capacitive discharge), or serve as acoustic cavitation sites. Chemical additives (308) or trace non-volatile impurities present in the process fluid (304) such as oxygen, nitrous oxide, argon and water are available to produce radicals, ozone, and other reactive species which enhance thermo-catalytic electro-catalytic and sono-catalytic contaminant treatments. Plasma energy (310), in the form of electrons and ultraviolet radiation, reacts with the contaminant (302) or additive (308) molecules to produce energetic radicals (312), which oxidatively degrade the contaminant (302) molecules. Finally, acoustic energy (314) is beneficially employed to enhance the overall treatment process by producing intense microscopic cavitation sites (316) at the solid-liquid interface—wherein localized pressure and temperature greatly exceed the bulk process fluid (304) conditions producing more energetic reactions such as release of contaminant by-products from catalytic surfaces (306) and the accelerated formation of innocuous treatment by-products such as carbon dioxide (316) and water (318). The reaction rate (320) of the present invention is measured in terms of the ability to decompose complex organic, metalorganic or halo-organic contaminants and generally increases with an increase in applied treatment energy (322). Thus the present invention utilizes incremental and combinational treatments to meet the desired end-product quality requirements, the type of high-pressure fluid—gas, liquid or supercritical fluid—being treated, and the nature and level of contamination present. Having thus described the various plasma and sono-plasma treatment devices and features as well as theoretical considerations, following is a detailed discussion of the use of the present invention in combination with process fluid supplies additives and applications.

Referring to FIG. 6a, the exemplary high-pressure plasma treatment system comprises a gas treatment cabinet (320), which utilizes a graphical user interface (322) and main power switch (324). The cabinet is connected to a supply tank (326) of high-pressure carbon dioxide gas using a gas connection line (328) with a regulated pressure of between 275 psi 70 F. A purified as line (330) and purified liquid connection line (332) are used together or separately to deliver plasma-treated process application (334). The user interface (322) is communicates with and controls the exemplary plasma treatment system (336), which is housed within the cabinet (320), using a Process Logic Controller (PLC) (338) and software. The PLC (338) is connected (340) to various valves, plasma power unit, condenser units, and sensor subsystems used in the treatment system (336). As shown in the treatment system design (336), a gas connection line (328) delivers pressure regulated carbon dioxide gas through an inlet valve (342), which when opened, delivers the high-pressure gas into the exemplary plasma treatment unit (344) through inlet pipe and port (346), as described in FIGS. 2 and 3. Following treatment, the treated carbon dioxide gas enters a pre-cooling condenser unit (348) through inlet pipe (350). Cooled treated fluid exits the pre-cooling condenser unit (348) through outlet pipe (352), whereupon the pre-cooled treated fluid enters a condenser coil (354) and is cooled to a liquid-phase carbon dioxide which fills a condensed fluid tank (356) through coil outlet pipe (358). A refrigeration system (360) recirculates cold heat exchange fluid through the condenser coil (354) and pre-cooling condenser (348). A high-level optical switch (362) and low-level optical switch (364), both available from Gems Sensors, control the volume of purified and liquefied product within the condensed fluid tank (356) as follows. The low-level optical switch (364) turns on the inlet valve (342), refrigeration unit (360) and plasma treatment unit (344) and the high-level optical switch (362) deactivates these same subsystems. A pressure sensor (366) and temperature sensor (368) give user feedback via the PLC (338) and interface monitor (322) as to pressure and temperature conditions within the purified supply tank. Purified gas is withdrawn from the condenser tank (356) through a gas outlet line (370) through a valve (372) and through a polishing particle filter (374). A pure gas connection line (330) is connected to the outlet of the polishing filter (374), which may be used directly in applications (334) such as beverage carbonation, inerting or may be used as a propellant gas. Purified liquid is withdrawn from the condenser tank (356) through a liquid outlet line (376) through a valve (378) and through a polishing particle filter (380). A pure liquid connection line (332) connects to the outlet of the polishing filter (380), which may be used in applications (334) such as liquid, solid and supercritical fluid cleaning or may be used as an ultra pure freezing agent. Finally, referring to FIG. 6b, it may be useful to pre-treat a liquid phase process fluid such as liquid carbon dioxide, following which the treated liquid is used as a source of ultra-pure gas, which can then be condensed and used in accordance with FIG. 6a.

Referring to FIG. 6b, a liquid carbon dioxide process fluid is introduced into the pretreatment system via inlet pipe (382) at a pressure of 832 psi at 70 F through inlet valve (384) and into a mixing tee (386) through an inlet pipe (388). Liquid nitrous oxide at a pressure of 745 psi and 70 F is injected into the mixing tee (386) through inlet pipe (390), inlet valve (392) and using an injection pump (394). The liquid nitrous oxide and liquid carbon dioxide are blended within the mixing tee (386) and are introduced into the exemplary sono-plasma treatment unit (396) through inlet port (398), in accordance with FIGS. 4a and 4b, whereupon the nitrous oxide additive is chemically reacted to produce oxygenated radicals and nitrogen gas. Sono-plasma treated liquefied gas exits the treatment unit (396) and into distillation tank 400. An optical sensor (402) is positioned near the top (404) of the distillation tank (400) and controls the operation of sono-plasma treatment unit (396), process fluid inlet valves (384, 392), and the injection pump (394). Purified gas is withdrawn from the upper hemisphere of the distillation tank (400) through outlet pipe (406) and through a media treatment cartridge (408). In various plasma or sono-plasma treatment applications, it may be beneficial to remove trace amounts of gas-phase halocarbon residues prior to or following treatment to prevent the delivery of hazardous or corrosive by-products. For example, fluorocarbon contaminants such as polyalkylfluorocarbons and perfluoroethers, which are recalcitrant oil-like compounds, are commonly found in trace levels in liquid and vapor phases of carbon dioxide. These contaminants, when subjected to oxidative attack using the present invention, will degrade into hydrofluoric acid (HF), a corrosive acid by-product. This trace acid may be used as a beneficial treatment chemistry in combination with plasma apparatuses and processes discussed herein. However, ultimately this corrosive by-product must be removed from the final purified product if present in significant quantity. The pack bed reactor within the plasma treatment unit (396) may contain silica gel and other particles, which serve as acid neutralizers. However, in order to mitigate the generation of HF or to remove trace HF following treatment, fluorocarbon impregnated silica gel may be used within the media treatment cartridge (408) to remove fluorinated precursor compounds following plasma treatment or sono-plasma treatments. Although not shown in the figure, a novel liquid carbon dioxide reverse phase separation process can be employed wherein trace fluorocarbon residues entrained in gas phase carbon dioxide are selectively removed and concentrated onto a fluorocarbon impregnated silica gel (Fluorosil). After a predetermined period of time, the Fluorosil becomes saturated with fluorocarbon contaminant and is back-washed with purified (plasma or sono-plasma treated liquid carbon dioxide) to remove the concentrated contaminants from the solid phase—thus regenerating the solid phase adsorbent. Between 700 psi and 1500 psi and 10C and 30 C, liquid carbon dioxide, a fluorocarbon loving solvent, solubilizes the adsorbed fluorocarbons from the Fluorosil, and within an expander-separator, the liquid-carbon dioxide is expanded to gas phase to precipitate out the fluorocarbon contaminants. Purified supercritical carbon dioxide may also be used as the regeneration agent as well, performed under pressure and temperature conditions of between 1200 psi and 2500 psi and 31 C and 50 C, respectively. The reverse phase separation process relies on the relatively large differences between the solubility chemistries (solubility parameters) of the vapor-phase contaminant, vapor phase fluid and liquid phase fluid constituents.

Finally, purified vapor exits the media treatment cartridge through an outlet pipe (410) and may be used as a gas or may be condensed and used as described in FIG. 6a. Moreover, a second gas-phase plasma treatment unit, described in FIGS. 4a and 4b, may be employed prior to or following the media treatment cartridge (408) to further purify the sono-plasma treated liquid.

Although the invention has been disclosed in terms of preferred embodiments, it will be understood that numerous variations and modifications could be made thereto without departing from the scope of the invention as set forth herein.

What I claim and desire to protect by Letters Patent is:

1. A process for purifying a dense dielectric fluid containing a contaminant comprising applying a plasma to a dense dielectric fluid containing a contaminant at a pressure, temperature, and for a time sufficient to oxidize the contaminant.

2. The method in accordance with claim 1 wherein the fluid is carbon dioxide.

3. The method in accordance with claim 1 wherein the plasma is created by a high voltage and high frequency electrical discharge.

4. The method in accordance with claim 3 wherein the electrical discharge is applied in pulses.

5. The method in accordance with claim 3 wherein the electrical discharge is applied continuously.

6. The method in accordance with claim 5 further comprising adding a reactant to the fluid before applying the plasma.

7. The method in accordance with claim 6 wherein the reactant is water, argon, nitrous oxide, hydrogen peroxide, oxygen or combinations thereof.

8. The method in accordance with claim 1 wherein the plasma is applied in a packed bed reactor.

9. The method in accordance with claim 8 wherein the reactor is packed with non-conductive solid particles.

10. The method in accordance with claim 9 wherein the solid particles are pure or metal impregnated activated alumina particles, barium oxide particles, silica gel particles, glass particles, ceramic particles, titanium dioxide particles, zeolites or combinations thereof.

11. The method in accordance with claim 1 wherein the plasma is created by acoustic energy.

12. The method in accordance with claim 11 wherein the plasma is applied in a packed bed reactor.

13. The method in accordance with claim 11 further comprising adding a reactant to the dielectric fluid before applying the plasma.

14. The method in accordance with claim 13 wherein the reactant is water, argon, nitrous oxide, hydrogen peroxide, oxygen or combinations thereof.

15. The method in accordance with claim 1 wherein the dense fluid is pre-treated prior to applying the plasma.

16. The method in accordance with claim 15 wherein the dense fluid in pretreated using silica gel reverse phase separation.

17. The method in accordance with claim 1 wherein the fluid has a dielectric constant between 1 and 80.

18. The method in accordance with claim 1 wherein the pressure is in the range between 3 atm and 300 atm.

19. The method in accordance with claim 1 wherein the temperature is in the range between −20° C. and 350° C.

20. The method in accordance with claim 3 wherein the frequency is in the range between 50 KHz and 4 MHz and the voltage is in the range between 1 KV and 200 KV.
